(19) United States
(12) Patent Application Publication
(10) Pub. No.: US 2026/0118196 A1
(43) Pub. Date: Apr. 30, 2026

(54) INTEGRATED NANO SCALE CAPACITIVE PRESSURE SENSOR AND ANALOG PHYSICAL UNCLONABLE FUNCTION (PUF)

(71) Applicant: Raytheon Company, Tewksbury, MA (US)

(72) Inventors: Parviz Saghizadeh, Encino, CA (US); Aaron GEORGE, San Diego, CA (US); Jason Michael KEHL, Inglewood, CA (US); Eric R. MILLER, Orcutt, CA (US); Haley M. STEFFEN, Cedar Rapids, IA (US)

(73) Assignee: Raytheon Company, Tewksbury, MA (US)

(21) Appl. No.: 18/933,190

(22) Filed: Oct. 31, 2024

(51) Int. Cl. G01L 9/00

(52) U.S. Cl. CPC G01L 9/0072

(57) ABSTRACT

A nano-scale capacitive pressure sensor formed of an array of capacitive pressure cells is disclosed. The capacitive pressure sensor is integrated with an ASIC working as a pressure sensor and a PUF. Each of capacitive pressure cells is a hermetically sealed cavity and includes a first stationary conductive membrane and a second conductive membrane that deflects due to a force (pressure change) applied on the array of capacitive pressure sensor cells. A method of manufacturing the nano-scale capacitive pressure sensor is also disclosed.

### FIELD OF THE INVENTION

The subject matter disclosed herein relates to capacitive pressure sensors that can also function as physical unclonable functions (PUFs). More particularly, these sensors are nano scale capacitive pressure sensors and PUFs that are integrated within an IC package to provide unique cryptographic key for device authentication and/or prevent the IC package from hardware cyber attack, cloning, counterfeit, and reverse engineering.

### BACKGROUND OF THE INVENTION

PUF (Physical Unclonable Function) is a technique in hardware security that exploits inherent device variations to produce an unclonable, unique device response to a given input. PUF has been used in ICs (integrated circuits), and offers everything from improved cryptography to anti-counterfeiting on the ICs. As every single IC ever produced physically differs from one another due to random physical factors introduced during fabrication, by exploiting this inherent difference in IC behavior, PUF provides a unique cryptographic key or fingerprint for each IC. In particular, a PUF is a physical function (not a mathematical function) which maps a digital “challenge” to a digital “response.” Unlike a conventional cryptographic approach, that uses a single stored key, the PUF works by implementing challenge-response authentication to generate the unique fingerprint for each IC.

Capacitive pressure sensors are pressure measurement devices, which operate based on a capacitive sensing technology and can convert an applied pressure into a current signal. The capacitive pressure sensors are used in many control and monitoring applications, such as flow, airspeed, level, pump systems, or altitude.

The disclosed embodiments aim to fabricate a capacitive pressure sensor on an IC package that can also function as a PUF.

### SUMMARY OF THE INVENTION

The present disclosure is directed, in some embodiments, to a pressure sensor device. The pressure sensor device includes an array of capacitive pressure sensor cells coupled to an electronic device, the array being formed of columns and rows of the capacitance pressure sensor cells, each of the capacitance pressure sensor cell being a hermetically sealed cavity including a first conductive membrane that is fixed in place and a second conductive membrane that is deflectable due to a force applied on the array of capacitive pressure sensor cells. The first and the second conductive membranes hermetically seal the cavity, wherein the cavity is partially filled with a gas, and wherein each of the capacitance pressure sensor cells has a unique capacitance value forming a signature for each of the capacitance pressure sensor cells.

The pressure sensor device functions as a pressure sensor and a PUF (physical unclonable function) device. Further, the capacitive value of each of the capacitive pressure cells changes due to a pressure change caused by the force applied on the array of capacitive pressure sensor cells.

The pressure sensor device further includes a capacitive measurement circuitry for measuring the capacitance values of the capacitive pressure sensor cells when a pressure or a pull force is applied on the array of the capacitive pressure sensor cells, and an analog to digital converter (ADC) for converting the capacitance values measured by the capacitive measurement circuitry to digital signals. The capacitance measurement circuitry of the pressure sensor device measures a relative capacitance value of each of the capacitive pressure cells. The digital signals converted by the ADC form a set of signatures for the array of capacitive pressure sensor cells, and a change of the pressure or the pull force applied on the array of the capacitive pressure sensor cells changes the capacitance values measured by the capacitance measurement circuitry. Further, if the change of capacitive values is over a predetermined range, the electronic device coupled with the array of capacitance disables certain critical operations or erase crypto information.

In the disclosed embodiments, the array of capacitive pressure cells of the pressure sensor device may be fabricated on an IC wafer or die where the IC is located. The array of capacitive pressure cells of the pressure sensor device may also be fabricated on a separate substrate and is integrated with the IC using one of through silicon vias (TSVs), wire-bonding, solder bumper attachment, copper pillar attachment, and/or wafer-wafer bond hybridization. Moreover, each of the capacitive pressure cells of the pressure sensor device is in nano-scale.

In yet another embodiment, the present disclosure is directed to an IC (integrated circuit) package. The IC package includes a wafer or die on which an application-specific IC (ASIC) is patterned and formed, and at least one array of capacitive pressure cells that is electrically interconnected with the ASIC. In the IC package, the at least one array of capacitive pressure cells is formed of columns and rows of the capacitance pressure sensor cells. Each of the capacitance pressure sensor cell is a hermetically sealed cavity including a first conductive membrane that is fixed in place and a second conductive membrane that is deflectable due to a force applied on the array of capacitive pressure sensor cells. Further, the first and the second conductive membranes enclose the cavity, and each of the capacitance pressure sensor cells has a unique capacitance value forming a signature for each of the capacitance pressure sensor cells.

In the disclosed embodiments, the ASIC includes a capacitance measurement circuit for measuring capacitance values of the capacitive pressure sensor cells when a pressure or a pull force is applied on the array of the capacitive pressure sensor cells, and an analog to digital converter (ADC) for converting the capacitance values measured by the capacitive measurement circuitry to digital signals. The capacitance measurement circuitry measures a relative capacitance value of each of the capacitive pressure cells.

The at least one array of capacitive pressure sensor cells is fabricated on a same wafer or die wherein the ASIC is patterned and formed. The at least one array of capacitive pressure cells may also be fabricated on a separate substrate and is integrated with the IC using one of through silicon vias (TSVs), wire-bonding, solder bumper attachment, copper pillar attachment, and/or wafer-wafer bond hybridization. Moreover, each of the capacitive pressure cells is in nano-scale.

The at least one array of capacitive pressure cells may also be fabricated during a BEOL (back end of the line) processing.

In yet another embodiment, the present disclosure is directed to a method for manufacturing an array of capacitive pressure sensor cells that functions as a pressure sensor and a PUF (physical unclonable function.) The method includes steps of preparing a wafer, depositing a dielectric layer on the wafer, depositing a first conductive layer on the dielectric layer and etching the first conductive layer to form bottom electrodes of the array of capacitive pressure sensor cells, depositing a layer of silicone dioxide and performing an etching procedure to create a structure of the array of the capacitive pressure sensor cells, forming a conductive pattern of the array of capacitive pressure sensors by depositing a conductor material and performing metal electroplating and chemical mechanical planarization, performing an etching back process to each some but not all of the conductive pattern to form a number of cavity spaces, wherein the number of cavity spaces correspond to the array of the capacitive pressure sensor cells, and each of the number of cavity spaces corresponds to one of the capacitive pressure sensor cells, and bonding and releasing a second conductive layer. The second conductive layer serves as top electrodes of the array of pressure sensor cells, and the second conductive layer seals the number of cavity spaces. Further, the bottom electrodes formed the first conductive layer are fixed in place and the top electrodes formed by the second conductive layer are deflectable due to a force applied thereon.

The method for manufacturing an array of capacitive pressure sensor cells further includes depositing a thin layer of dielectric materials over the bottom electrodes after the etching back process.

### BRIEF DESCRIPTION OF FIGURES

The features of the disclosure believed to be novel and the elements characteristic of the invention are set forth with particularity in the appended claims. The figures are for illustration purposes only and are not drawn to scale. The disclosure itself, however, both as to organization and method of operation, can best be understood by reference to the description of the preferred embodiment(s) which follows, taken in conjunction with the accompanying drawings in which:

FIG. 1 depicts a diagram of a capacitance measurement circuitry together with the capacitance array to be measured in accordance with the disclosed embodiments.

FIG. 2 depicts a general structure of a single pressure sensor cell in accordance with the disclosed embodiments.

FIG. 3 illustrates how a change of distance between a first membrane and a second membrane in a capacitive pressure sensor cell in accordance with the disclosed embodiment changes the capacitance value of the pressure sensor cell.

FIG. 4A depicts a scenario where the pressure external to the cell cavity is less than the pressure inside the cavity denoted by X atm.

FIG. 4B depicts a scenario where the pressure external to the cell cavity is equal to the pressure inside the cavity.

FIG. 4C depicts a scenario where the pressure external to the cell cavity is greater than the pressure inside the cavity.

FIG. 5 illustrates a flowchart for manufacturing the array of pressure sensor cells in accordance with the disclosed embodiments.

FIG. 6 illustrates a conceptual cross-sectional schematic diagram of an IC package in accordance with the disclosed embodiments.

FIG. 7 illustrates a process of manufacturing an IC package in accordance with the disclosed embodiments, in which at least one capacitive pressure sensor is integrated with an ASIC wafer or die.

### DETAILED DESCRIPTION OF THE INVENTION

The embodiments of the present disclosure can comprise, consist of, and consist essentially of the features and/or steps described herein, as well as any of the additional or optional ingredients, components, steps, or limitations described herein or would otherwise be appreciated by one of skill in the art.

Reference will now be made in detail to specific embodiments of the present invention. Examples of these embodiments are illustrated in the accompanying drawings. Numerous specific details are set forth in order to provide a thorough understanding of the present invention. While the embodiments will be described in conjunction with the drawings, it will be understood that the following description is not intended to limit the present invention to any one embodiment. On the contrary, the following description is intended to cover alternatives, modifications, and equivalents as may be included within the spirit and scope of the appended claims.

The present disclosure is directed to a capacitive pressure sensor that integrates with an IC (integrated circuit) package to detect environmental changes in pressure due to a volume intrusion. The capacitive pressure sensor can also work as an altitude pressure sensor and an analog physical unclonable function (PUF) to provide a unique device identification similar to a human fingerprint. As a physical unclonable function (PUF), the pressure capacitive sensor provides defense against hardware cyber attack by providing a unique seed or key for RNG (random number generation), authentication, counterfeit detection or encryption. The capacitive pressure sensor includes an array of nano-scale sensor cells integrated within an IC package to detect pressure changes in a die or the package as a result of any physical attack, reverse engineering, or any form of anomaly that impact the relative pressure in the IC volume or the cavity within which the capacitive pressure sensor. Each of the pressure sensor cell is a hermetically sealed cavity with two conductive membranes in parallel separated by a nominal distance forming a capacitor. One membrane is fixed in place and the other is free to deflect with changes in pressure. The change in the cavity's external pressure is proportional to the change in capacitance of the sensor cell. Based on the change of the external pressure, the disclosed embodiments are able to detect an IC decapsulation, FIB (focused ion beam) editing/attack, or any penetration that causes the pressure change.

In the disclosed embodiments, the array of nano-scale sensor cells is made up of rows and columns of the pressure capacitor cells. Cell size may be in 10s to 100s of nm. The array of nano-scale capacitor cells may be integrated within an IC package on a same die or a different die functioned as a master die to detect pressure changes in the die or the package as a result of FIBing (focused ion beaming), reverse engineering, or any form of physical attack. As a PUF, the array generates analog outputs from the detected pressure changes that are sent to analog-digital converters (ADCs) to provide a non-binary signature. In accordance with the disclosed embodiments, the output of each cell may be 12-bit wide, as an example, resulting in extreme difficulty for an adversary to guess the value of the output.

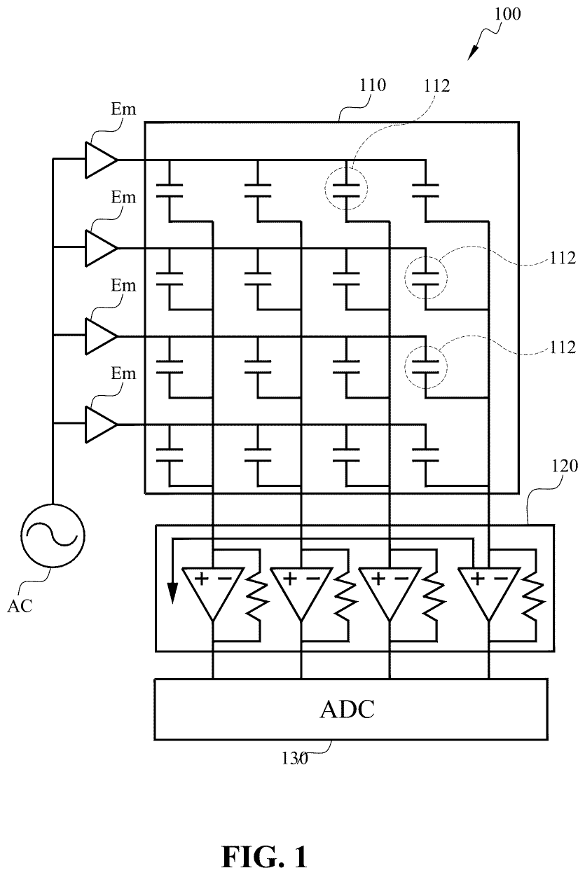

FIG. 1 illustrates a schematic diagram of a capacitive pressure sensor device 100 that works both as a pressure sensor and a PUF device in accordance with the disclosed embodiments. Capacitive pressure sensor device 100 includes a pressure sensor array 110 formed of columns and rows of pressure sensor cells 112, a capacitance measurement circuit 120, and an ADC (analog-digital converter) 130. Each pressure sensor cell 112 of pressure sensor array 110 is a parallel-plate-type capacitor cell formed of two parallel membranes with a cavity hermetically sealed by the two parallel membranes. The two membranes form the two electrodes of the pressure sensor cell 112, in which one membrane is fixed in place (i.e., stationary,) and the other membrane is non-stationary, which can be deflected with a pressure or force. Therefore, the pressure sensor cell 112 is also called a capacitor cell, or pressure cavity sensor.

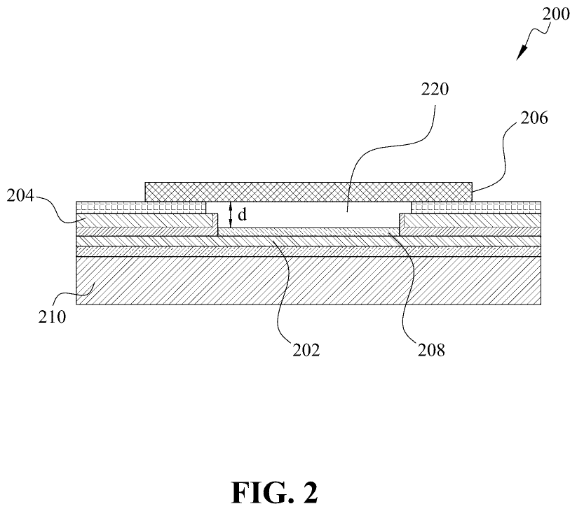

A driver En applies a voltage to the electrodes of pressure sensor cells 110 and capacitance measurement circuit 120 measures their corresponding capacitances. The capacitance of each pressure sensor cell 112 is proportional to the distance between its two membranes. In accordance with the disclosed embodiments, pressure sensor cells 112 of array 110 may be patterned on an active ASIC wafer or die. Pressure sensor array 110 may also be fabricated on a separate substrate first and then integrated with an active ASIC using through silicon vias (TSVs), wirebonding, solder bump attachment, copper pillar attachment, and/or wafer-wafer direct bond hybridization. Details of pressure sensor cell 112 will be illustrated and described in FIG. 2 below.

Capacitance measurement circuitry 120 measures the capacitance of each pressure sensor cell 112. In the disclosed embodiments, to eliminate or minimize the effect of aging, ambient and/or operating temperature, internal stress and other environmental factors on the pressure sensor cell 112, capacitance measurement circuitry 120 measures a relative capacitance, instead of an actual capacitance, of each pressure sensor cell 112. For example, if a target nominal cell capacitance is 100 to 500 fF and a target range of a pressure change is ΔC (capacitance delta)=2% or greater. Therefore, a relative ΔC measurement resolution will be sub fF.

The relative capacitance of each pressure sensor cell measured by capacitance measurement circuitry 120 is an analog output that is then sent to ADC 130 for processing. ADC 130 is used to convert the analog output of each pressure sensor cell 112 into digital data and store the digital data as a non-binary signature for each pressure sensor cell 112. A set of non-binary signatures is then obtained for the pressure sensor array 110. Due to process variations related to the dimensions of each pressure sensor cell 112, a stiffness of the non-stationary membrane and a gas volume in the cell, each pressure sensor cell 112 will exert its own unique pressure level and capacitance. Therefore, it is expected that the pressure sensor array 110 to have a unique set of signatures, thereby allowing it to be used as both a sensor and a PUF. In accordance with the disclosed embodiments, the analog output of each pressure sensor cell may be, for instance, 12-bit wide, which makes it extreme difficult for an adversary to guess the value thereof.

Each pressure sensor cell or cavity 112 has a nano-scale dimension that may be scaled to dimensions of 10s to 100s of nm (diameter, membrane thickness, electrode separation, etc.) Therefore, it provides a sub-micron electrode spacing to enable higher capacitance and larger capacitance delta over pressure change.

Array of capacitive pressure sensor cells 110 in accordance with the disclosed embodiment may be fabricated integrally with a manufacturing process of an active ASIC or die. Alternatively, array of capacitive pressure sensor cells 110 may be fabricated on a separate substrate which is then attached on the active ASIC or die. Further, array of capacitive pressure sensor cells 110 may be fabricated during a BEOL (Back End Of Line) processing.

FIG. 2 illustrates a general structure of a single pressure sensor cell 200 in accordance with the disclosed embodiments. It is noted that pressure sensor cell 200 is the same as pressure sensor cell 201 of FIG. 1. Rows and columns of pressure sensor cell 200 constitutes array 110 of FIG. 1.

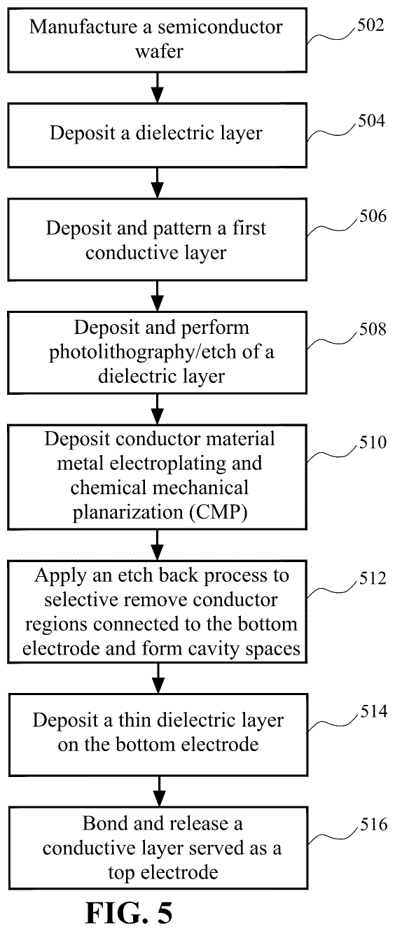

In FIG. 2, pressure sensor cell 200 is a hermetically sealed cavity with two parallel membranes, i.e., a first membrane 202 and a second membrane 206 that are separated by a nominal distance d. Both of the first and second membranes 202 and 206 are metallic layers, in which first membrane 202 forms a bottom electrode and second membrane 206 forms a top electrode. In some embodiments, a thin dielectric layer 208 is further formed on the top of second membrane 206 by an atomic layer deposition (ALD) process or similar processes which eliminates the risk of shorting the electrodes together and also provides increased capacitance and/or capacitance variation between capacitor cells within the array. During a fabrication process of pressure sensor cell 200, cavity space 220 may be filled partially with a gas such as Nitrogen and sealed. Details of manufacturing the pressure sensor cell or cavity 200 will be described with FIG. 5 later.

Further, pressure sensor cell 200 has a broad entropy due to the metal etch back process, which creates random variation in the bottom metal electrode roughness and spacing between electrodes, thus providing a unique capacitance signature for the die. First membrane 202, also the bottom electrode, is patterned on a substrate 210 and has random variation in the metal thickness and roughness. The above-mentioned metal etch back process could further take care of smoothing the roughness surface of the first membrane 202. Second membrane 206, i.e., the top electrode and also called a pressure sensor membrane, is a thin metallic layer hermetically bonded to metal layers on substrate 210 to form an electrical interconnect. The design and fabrication architecture of pressure sensor cell 200 provides randomness that are dependent only on process variations. They are unique from die to die and pressure sensor cell has a very high entropy. Further, the randomness that depends only on the process variations may be in famto-Farad (fF) level range. As mentioned above, the output of the array of pressure sensor cells are analog capacitance values.

First membrane 202 is a stationary membrane that is not deflectable with force. Second membrane 206, however, is a non-stationary membrane that is deflectable due to a pressure or a force applied thereon. As stated above, the capacitance value of the pressure sensor cell 200 changes dependent on the distance d between first membrane 202 and second membrane 206. Therefore, a change in pressure on second membrane 206 will cause the signature of the pressure sensor cell 200 to change. When the signature changes over a predetermined range, it causes the IC to take defensive steps, such as disabling critical operations or erasing crypto information. The defensive steps may be preset steps designated during the design and the manufacturing process of the IC and are not limited to the above-mentioned steps.

As second membrane 206 is non-stationary and deflectable so that the distance d between first membrane 202 and second membrane 206 changes due to a pressure or force applied on second membrane 206, causing a capacitance value of pressure sensor cell 200 to be changed.

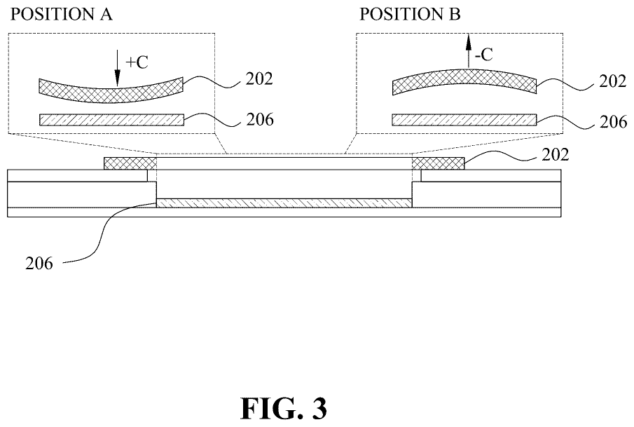

FIG. 3 illustrates how the movement of first membrane 202 in relation to the stationary second membrane 206 changes the capacitance value of pressure sensor cell 200. As shown, when a force or pressure is applied on second membrane 206 (position A), second membrane 206 moves toward first membrane 202 so that their distance d is reduced and the capacitance value is increased. However, when second membrane 206 is pulled away (by a force) from first membrane 202 (position B), the distance d increases and the capacitance value becomes smaller. It is noted that the change in an external pressure (or force) is proportional to the change in the capacitance value.

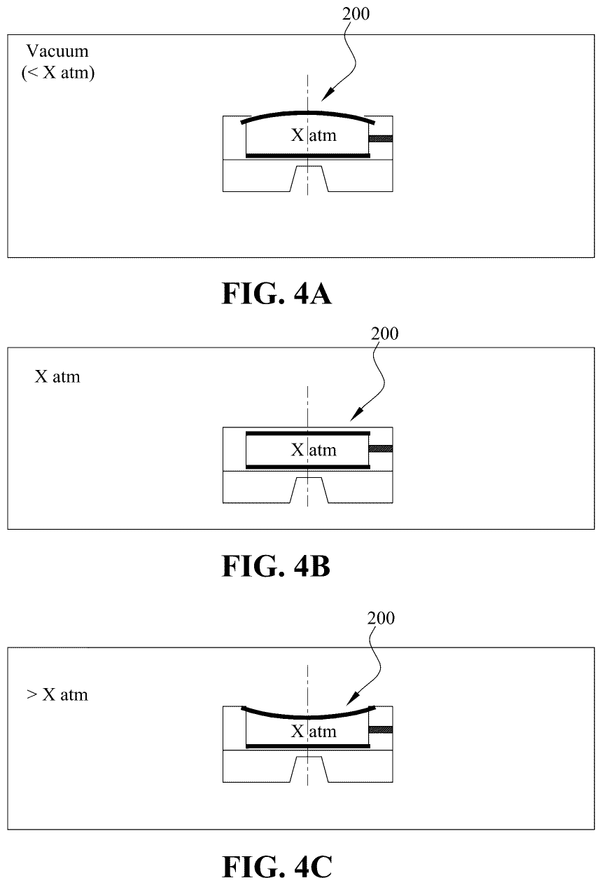

FIGS. 4A, 4B, and 4C further illustrates exemplary diagrams of pressure sensor cell 200 under different scenarios with changes of a pressure or relative pressure.

FIG. 4A depicts a scenario where the pressure external to the cell cavity is less than the pressure inside the cavity denoted by X atm. FIG. 4B depicts a scenario where the pressure external to the cell cavity is equal to the pressure inside the cavity. FIG. 4C depicts a scenario where the pressure external to the cell cavity is greater than the pressure inside the cavity. Any changes to the relative external to internal pressures will cause the upper plate of the cell to move, thereby changing the capacitance measurement. The change in pressure can be initiated by de-liding the IC, reverse engineering attempt, FIBing or any other intrusion that can impact the said relative pressure.

As described with reference to FIG. 1, capacitance measurement circuitry 120 measures the relative capacitance value of pressure sensor cell 200 and sends the measured value to ADC 130 for converting into a non-binary signature for pressure sensor cell 200. As will be described below with FIG. 5, when an array of pressure sensor cells, such as cells 200, is fabricated on an ASIC die, if the change of the relative capacitance is over a predetermined value, the ASIC die will take certain defensive steps, such as disabling critical operations or erasing crypto information to guard against counterfeiting, reverse engineering, FIBing, or any other form of physical attack.

In accordance with the disclosed embodiment, to work as an altitude pressure sensor and a PUF, an array of pressure sensor cells, such as array 110 of FIG. 1 may be integrated within an IC package. As already mentioned, an array of pressure sensor cells may be patterned on an active ASIC or a die or on a separate substrate. In the latter, the array of pressure sensor cells can then be integrated to an active ASIC or a die using a variety of methods, such as through silicon vias (TSVs), wire-bonding, solder bump attachment, copper pillar attachment, and/or wafer-wafer direct bond hybridization, which will be described in more details below.

FIG. 5 illustrates a flowchart 500 for manufacturing the array of pressure sensor cells 110 in accordance with the disclosed embodiments. As described above, the array of pressure sensor cells or capacitive cells 110 is formed on a substrate. As well known in the art, the manufacturing of a microelectronics product involves complicated procedures, such as photolithography patterning, depositing, etching, masking, chemical mechanical planarization and so on. Therefore, the following descriptions regarding flowchart 500 will be simplified to focus on the procedures of manufacturing the cavity structure of the array 110 of the disclosed embodiments.

Step 502 executes by manufacturing the substrate. As conventionally known, the substrate is a silicon wafer.

Step 504 executes by depositing a dielectric layer of silicon dioxide (SiO₂) on the silicon wafer. The layer of SiO₂ would act as the dielectric material for the array of the pressure sensor or capacitive cells 110.

Step 506 executes by depositing a first conductive layer, patterned by applying a photolithography procedure and performing an etching procedure to etch away exposed areas of the conductor layer. This etching procedure can be done using wet or dry etching techniques. This layer will serve as bottom electrodes of the array 110, such as bottom electrode 202 of FIG. 2.

Step 508 executes by depositing a layer of silicon dioxide (SiO₂) over the conductor layer, applying a photolithography procedure and performing an etching procedure to etch away exposed areas of the dielectric layer to create a structure of the array 110. This etching procedure can be done using wet or dry etching techniques. These processes can be repeated to form two dielectric patterns to create a structure of the array 110.

Step 510 executes by deposition of a conductor material, metal electroplating and chemical mechanical planarization (CMP) to form a conductor pattern of the array 110.

Step 512 executes by performing an etching back process to etch some but not all of first conductive layer on specific regions and to form a number of cavity spaces, such as cavity space 220 of FIG. 2. The number of cavity spaces corresponds to the array of pressure sensor cells. As stated above, the first conductive layer, also the bottom electrode, has random variation in the metal thickness and roughness.

Afterward, step 514 executes by depositing a thin dielectric layer over the bottom electrode by an atomic layer deposition (ALD) process or other similar process. The thin dielectric layer would help eliminating the risk of shorting the electrodes together and also provides increased capacitance and/or capacitance variation between capacitive cells within the array.

Next, step 516 executes by bonding and releasing a second conductive layer that will be served as a top electrode, such as top electrode 206. The second conductive layer also seals the cavity spaces. Accordingly, the array of pressure sensor cells or capacitive cells is then formed.

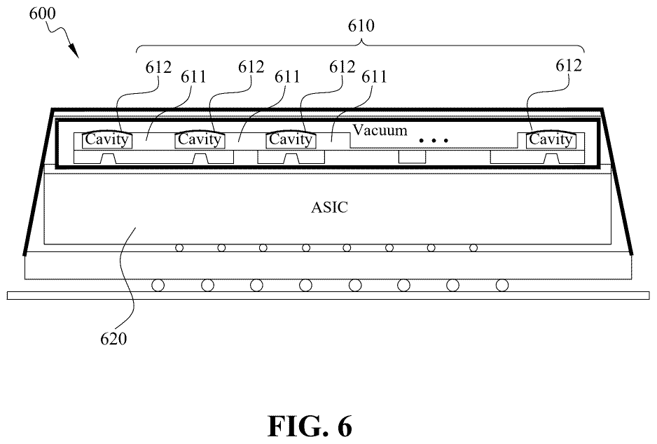

FIG. 6 illustrates a schematic diagram of an IC package 600 in accordance with the disclosed embodiments, in which an array 610 formed of columns and rows of nano-scale capacitive pressure sensor cells or cavities 612 is bonded (areas 611) or patterned on the top of an active ASIC die 620. Each capacitive pressure sensor cells or cavities 612 has a same structure of pressure sensor cell or cavity 200 shown in FIG. 2. Array 610 is similar to array 110 of FIG. 1.

Array 610 of capacitive pressure sensor cells or cavities 612 is integrated within IC package 600 on a same die of the ASIC die 620. Array 610 of capacitive pressure sensor cells may also be integrated within a master die that is different from active ASIC die 620. Array 610 detects pressure change on the die 620 or the package 600 caused by abnormal forces, such as FIBing, reverse engineering, or any other form of physical attack. When the pressure changes in the array cavity 611 on the die 620 or the package 600, the capacitance values of array 610 will also change, that in turn causes the unique set of signatures of array 610 to change. As the signature of each pressure sensor cell or cavity 612 can be for instance 12-bit wide, it is extremely difficult for an adversary to guess the set of signatures of array 610. Therefore, array 610 detects IC decapsulation, FIB editing/attack, and any penetration that causes pressure change and also acts as a PUF for ASIC die 620.

In some embodiments, array 610 may be wrapped in thermally insulating material, but not limited. Further, the membranes of each pressure sensor cell or cavity may be connected to a protective layer and/or an IC lid of IC package 600 in such a way that if the lid or the protective layer is removed or drilled into the membranes, the membranes will break off to unseal the cell or cavity causing pressure change

In some embodiments, array 610 may be enclosed and wrapped in a protective sealed array membrane 611 surrounding the entire array, but not limited. The array membrane could be vacuum or filled with some gas. Further, the array membrane may be connected to a protective layer and/or an IC lid of IC package 600 in such a way that if the lid or the protective layer is removed or drilled into the array membrane, the membrane will break off to unseal the array cavity causing pressure change. The relative pressure between the pressure within the array cavity and the pressures within different cell cavities provide the unique PUF signature. Any disturbance of the array cavity that would change its pressure will cause a change in the PUF signature.

The array of pressure sensor cells 610 may be fabricated on ASIC die 620 or on a separate substrate and then mounted on ASIC die 620 by means of methods including through silicon vias (TSVs), wire-bonding, solder bump attachment, copper pillar attachment, and or wafer-wafer direct bond hybridization. The array of pressure sensor cells 610 may be arranged in n×n row/column configuration where n is an integer such that individual pressure sensors can be address by location. Further, more than one array may be mounted on ASIC die 620.

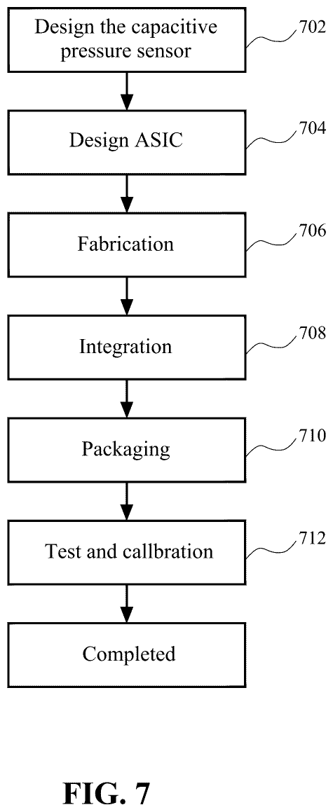

FIG. 7 illustrates a process 600 of manufacturing an IC package in which at least one capacitive pressure sensor as a pressure sensor and a PUF is integrated with an ASIC wafer or die worked in accordance with the disclosed embodiments. The flow chart 600 begins with designing the capacitive pressure sensor and the ASIC so that ASIC can be interfaced with the capacitive pressure sensor.

Step 702 executes by designing at least one capacitive pressure sensor according to application's requirements and purposes. The capacitive pressure sensor is an array of capacitive pressure sensor cells, or cavities, of which the design and structure are as shown in FIGS. 1-5 described above. The step involves selecting appropriate materials and dimensions for the membranes, such as first membrane 202 and second membrane 206 of FIG. 2, to achieve the desired sensitivity and range. In accordance with the disclosed embodiments, more than one capacitive pressure sensor may be integrated with an ASIC wafer or die, either fabricated on the ASIC wafer or die or on a separate substrate.

Step 604 executes by designing the ASIC wafer or die so that it can interface with the at least one capacitive pressure sensor. This step includes creating the necessary analog front-end circuitry to process signals sensed by the at least one capacitive pressure sensor. The necessary analog front-end circuitry may include capacitance measurement circuitry 120 of FIG. 1. The ASIC should be capable of measuring the capacitance changes accurately and converting them into a digital signal. That is, the ASIC wafer or die may include an ADC (an Analog-Digital Converter.) In some embodiments, the ADC may be fabricated in a separate die but is interconnected with the ASIC wafer or die.

Step 606 executes by fabricating both the at least one capacitive pressure sensor and the ASIC using semiconductor manufacturing processes, such as photolithography, etching, and deposition. As described above, the at least one capacitive pressure sensor maybe fabricated on a separate substrate or directly on the ASIC wafer or die, depending on the design.

Step 608 executes by integrating the at least one capacitive pressure sensor with the ASIC wafer or die if the at least capacitive pressure sensor is fabricated separately. This is done using techniques like flip-chip bonding, wire-bonding, TSVs, solder bump attachment, copper pillar attachment, and/or wafer-wafer direct bond hybridization. This step ensures that the electrical connections between the at least one capacitive pressure sensor and the ASIC are reliable and have a low parasitic capacitance.

Next, step 610 executes by packaging the at least one capacitive pressure sensor and the ASIC to protect them from environment factors and to provide a means of connecting to an external circuitry. The packaging should be designed to minimize any additional capacitance that could affect the sensor's performance.

Before the IC package is ready for commercialized use, the IC package needs to be tested and calibrated, as shown in step 612. That is, step 612 executes by verifying that the sensor operates correctly and that the ASIC accurately processes the signals detected by, for instance, capacitance measurement circuitry 120 of FIG. 1. Step 602 further executed by calibrating the IC package by adjusting parameters of the ASIC to compensate for any variations in the characteristics of the at least one capacitance pressure sensor.

Once the test and calibration are completed, the process 600 is completed.

As described, as every manufacturing process varies, each of the at least one capacitive pressure sensor is expected to have its unique signatures. Therefore, by detecting and converting the capacitive values corresponding to a change of pressure applied thereon, the at least one capacitive pressure sensor can be used as a pressure sensor and a PUF. Further, the capacitive pressure sensor is in a nano scale that provides a sub-micron dimension and fF resolution.

A customizable blend solution may be created for a specific part and damaged location which addresses not only geometric considerations, but also, using methods such as the XRD method, can more precisely detect the surface residual stress. This allow an optimized material removal and a more precise stress state of the component so that the optimized life for the component can be achieved. Various embodiments can be implemented by customizing different algorithms based on customers' defined solutions, and by dynamically changing or altering the solution through real-time feedbacks.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing than the appended claims, in which reference to an element is the singular is not intended to mean “one and only one” unless explicitly so stated, but rather “one or more”. Moreover, wherein a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods, and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Numbers, percentages, or other values stated herein are intended to include that value, and also other values that are about or approximately equal to the stated value, as would be appreciated by one of ordinary skill in the art encompassed by various embodiments of the present disclosure. A stated value should therefore be interpreted broadly enough to encompass values that are at least close enough to the stated value to perform a desired function or achieve a desired result. The stated values include at least the variation to be expected in a suitable industrial process, and may include values that are within 10%, within 5%, within 1%, within 0.1%, or within 0.01% of a stated value. Additionally, the terms “substantially,” “about” or “approximately” as used herein represent an amount close to the stated amount that still performs a desired function or achieves a desired result. For example, the term “substantially,” “about” or “approximately” may refer to an amount that is within 10% of, within 5% of, within 1% of, within 0.1% of, and within 0.01% of a stated amount or value.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, it should be understood that any of the above described concepts can be used alone or in combination with any or all of the other above described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

While the present disclosure has been particularly described, in conjunction with specific preferred embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the present disclosure.

What is claimed is:

1. A pressure sensor device, comprising:
an array of capacitive pressure sensor cells coupled to an electronic device, the array being formed of columns and rows of the capacitance pressure sensor cells, each of the capacitance pressure sensor cell being a hermetically sealed cavity including a first conductive membrane that is fixed in place and a second conductive membrane that is deflectable due to a force applied on the array of capacitive pressure sensor cells,
wherein the first and the second conductive membranes hermetically seal the cavity, wherein the cavity is partially filled with a gas, and wherein each of the capacitance pressure sensor cells has a unique capacitance value forming a signature for each of the capacitance pressure sensor cells.

2. The pressure sensor device of claim 1, wherein the electronic device includes an integrated circuit (IC).

3. The pressure sensor device of claim 1, wherein the capacitive value of each of the capacitive pressure cells changes due to a pressure change caused by the force applied on the array of capacitive pressure sensor cells.

4. The pressure sensor device of claim 3, further comprises
a capacitive measurement circuitry for measuring the capacitance values of the capacitive pressure sensor cells when a pressure or a pull force is applied on the array of the capacitive pressure sensor cells; and
an analog to digital converter (ADC) for converting the capacitance values measured by the capacitive measurement circuitry to digital signals.

5. The pressure sensor device of claim 1, wherein the pressure sensor functions as a pressure sensor and a PUF (physical unclonable function) device.

6. The pressure sensor device of claim 2, wherein the array of capacitive pressure cells is fabricated on an IC wafer or die where the IC is located.

7. The pressure sensor device of claim 2, wherein the array of capacitive pressure cells is fabricated on a separate substrate and is integrated with the IC using one of through silicon vias (TSVs), wire-bonding, solder bumper attachment, copper pillar attachment, and/or wafer-wafer bond hybridization.

8. The pressure sensor device of claim 1, wherein each of the capacitive pressure cells is in nano-scale.

9. The pressure sensor device of claim 4, wherein the capacitance measurement circuitry measures a relative capacitance value of each of the capacitive pressure cells.

10. The pressure sensor device of claim 4, wherein the digital signals converted by the ADC form a set of signatures for the array of capacitive pressure sensor cells, and a change of the pressure or the pull force applied on the array of the capacitive pressure sensor cells changes the capacitance values measured by the capacitance measurement circuitry.

11. The pressure sensor device of claim 10, wherein when the change of capacitive values is over a predetermined range, the electronic device coupled with the array of capacitance disables certain critical operations or erase crypto information.

12. An IC (integrated circuit) package, comprising:
a wafer or die on which an application-specific IC (ASIC) is patterned and formed; and
at least one array of capacitive pressure cells that is electrically interconnected with the ASIC,
wherein the at least one array of capacitive pressure cells is formed of columns and rows of the capacitance pressure sensor cells, each of the capacitance pressure sensor cell is a hermetically sealed cavity including a first conductive membrane that is fixed in place and a second conductive membrane that is deflectable due to a force applied on the array of capacitive pressure sensor cells, and
wherein the first and the second conductive membranes enclose the cavity, and wherein each of the capacitance pressure sensor cells has a unique capacitance value forming a signature for each of the capacitance pressure sensor cells.

13. The IC package of claim 12, wherein the ASIC includes a capacitance measurement circuit for measuring capacitance values of the capacitive pressure sensor cells when a pressure or a pull force is applied on the array of the capacitive pressure sensor cells, and an analog to digital converter (ADC) for converting the capacitance values measured by the capacitive measurement circuitry to digital signals.

14. The IC package of claim 12, wherein the at least one array of capacitive pressure sensor cells is fabricated on a same wafer or die wherein the ASIC is patterned and formed.

15. The IC package of claim 12, wherein the at least one array of capacitive pressure cells is fabricated on a separate substrate and is integrated with the IC using one of through silicon vias (TSVs), wire-bonding, solder bumper attachment, copper pillar attachment, and/or wafer-wafer bond hybridization.

16. The IC package of claim 12, wherein each of the capacitive pressure cells is in nano-scale.

17. The IC package of claim 13, wherein the capacitance measurement circuitry measures a relative capacitance value of each of the capacitive pressure cells.

18. The IC package of claim 12, wherein the at least one array of capacitive pressure cells is fabricated during a BEOL (back end of the line) processing.

19. A method for manufacturing an array of capacitive pressure sensor cells, wherein the capacitive pressure sensor functions as a pressure sensor and a PUF (physical unclonable function,) the method comprising:
preparing a wafer;
depositing a dielectric layer on the wafer;
depositing a first conductive layer on the dielectric layer and etching the first conductive layer to form bottom electrodes of the array of capacitive pressure sensor cells;
depositing a layer of silicone dioxide and performing an etching procedure to create a structure of the array of the capacitive pressure sensor cells;
forming a conductive pattern of the array of capacitive pressure sensors by depositing a conductor material and performing metal electroplating and chemical mechanical planarization;
performing an etching back process to each some but not all of the conductive pattern to form a number of cavity spaces, wherein the number of cavity spaces correspond to the array of the capacitive pressure sensor cells, and each of the number of cavity spaces corresponds to one of the capacitive pressure sensor cells; and
bonding and releasing a second conductive layer, wherein the second conductive layer serves as top electrodes of the array of pressure sensor cells, and wherein the second conductive layer seals the number of cavity spaces,
wherein the bottom electrodes formed the first conductive layer are fixed in place and the top electrodes formed by the second conductive layer are deflectable due to a force applied thereon.

20. The method of claim 19, further comprising depositing a thin layer of dielectric materials over the bottom electrodes after the etching back process.
